(19) United States
(12) Patent Application Publication
(10) Pub. No.: US 2016/0027087 A1
(43) Pub. Date: Jan. 28, 2016

(54) METHODS FOR PROVIDING TARGETED NOTIFICATIONS FOR COLOR MATCHED CONSUMER PRODUCTS AND DEVICES THEREOF

(71) Applicant: ColorModules Inc., New York, NY (US)

(72) Inventor: Asmau Ahmed, New York, NY (US)

(21) Appl. No.: 14/805,726

(22) Filed: Jul. 22, 2015

Related U.S. Application Data
(60) Provisional application No. 62/027,397, filed on Jul. 22, 2014.

(51) Int. Cl. G06Q 30/06

(52) U.S. Cl. CPC G06Q 30/0631

(57) ABSTRACT

A method, non-transitory computer readable medium, and a data management computing device that assists with providing targeted notifications for color matched consumer products includes obtaining a color image of an object from a consumer computing device. The object in the obtained color image is analyzed to identify one or more color characteristics. One or more consumer products are identified at least based on the identified color characteristics. One or more targeted notifications is provided for the identified one or more consumer products via one or more communication channels to the consumer computing device.

This application claims the benefit of U.S. Provisional Patent Application Ser. No. 62/027,397, filed on Jul. 22, 2014, which is hereby incorporated by reference in its entirety.

### FIELD

This technology generally relates to providing targeted notifications to consumers, more particularly, to methods for providing targeted notifications for color matches consumer products and devices thereof.

### BACKGROUND

In the current scenario, there is a high demand for effective ways of providing or selling consumer products. It is particularly a challenge for industries to sell products online that are dependent on color as part of purchase such as beauty, fashion and home (such as wall color, paintings and/or furniture) because of the difficulties consumers experience while identifying a color match with product that they already own. Additionally, consumers are also unsure of whether the color of the products present on the website would actually be the same in reality. However, when the consumer buys products online that require a color match, the consumer products are returned back as colors were not a match.

Existing technologies requires consumers to visit stores to purchase color coordinated. However, the overwhelming amount of choices and the inconvenience of using color samples, swatches make the process of shopping for color particularly tedious. Additionally, existing technologies do not provide any sort of targeted notifications to the consumers recommending color match consumer products.

### SUMMARY

This technology provides a number of advantages including providing a method, non-transitory computer readable medium and apparatus that assists with method for providing targeted notifications for color matches consumer products. In this example, the product recommendation engine within the recommendation management computing device identifies consumer products to the consumers based on a color match and then the color based product recommendation module provides targeted notifications to the consumers via one of a plurality of possible communication channels. By way of example only, the communication channels may include a text message, a voice call, a targeted notification on an executing application, web flash sales and/or targeted notifications on social media platforms. Additionally, this technology also provides targeted notifications to family and/or friends of a consumer which could be used by them to gift color matched consumer products to the consumer. This exemplary technology provides benefits to the consumer by dynamically identifying consumer products based on color match and providing targeted notifications in real-time over a variety of different communication channels.

One of several advantages of this exemplary technology is that the targeted notifications are provided in real-time when the consumer is either physically or geographically closer to the color matched consumer product. Further, this exemplary technology advantageously requires minimum information from the consumer, such as an image, and does not require any other information to identify a consumer product.

A method for providing targeted notifications for color matched consumer products includes obtaining, by a recommendation management computing device, a color image of an object from a consumer computing device. The object in the obtained color image is analyzed by the recommendation management computing device to identify one or more color characteristics. One or more consumer products are identified by the recommendation management computing device at least based on the identified color characteristics. One or more targeted notifications is provided by the recommendation management computing device for the identified one or more consumer products via one or more communication channels to the consumer computing device.

A non-transitory computer readable medium having stored thereon instructions for providing targeted notifications for color matched consumer products comprising machine executable code which when executed by at least one processor, causes the processor to perform steps includes obtaining a color image of an object from a consumer computing device. The object in the obtained color image is analyzed to identify one or more color characteristics. One or more consumer products are identified at least based on the identified color characteristics. One or more targeted notifications is provided for the identified one or more consumer products via one or more communication channels to the consumer computing device.

A recommendation management computing device comprising a processor, a memory, wherein the memory coupled to the processor which is configured to execute programmed instructions stored in the memory includes obtaining a color image of an object from a consumer computing device. The object in the obtained color image is analyzed to identify one or more color characteristics. One or more consumer products are identified at least based on the identified color characteristics. One or more targeted notifications is provided for the identified one or more consumer products via one or more communication channels to the consumer computing device.

### BRIEF DESCRIPTION OF THE DRAWINGS

FIG. 1 is a block diagram of an example of an environment with a recommendation management computing device for providing targeted notifications for color matches consumer products;

FIG. 2 is a functional block diagram of the example of the recommendation management computing device shown in FIG. 1; and

FIG. 3 is a flowchart illustrating an example of a method for providing targeted notifications for color matches consumer products.

### DETAILED DESCRIPTION

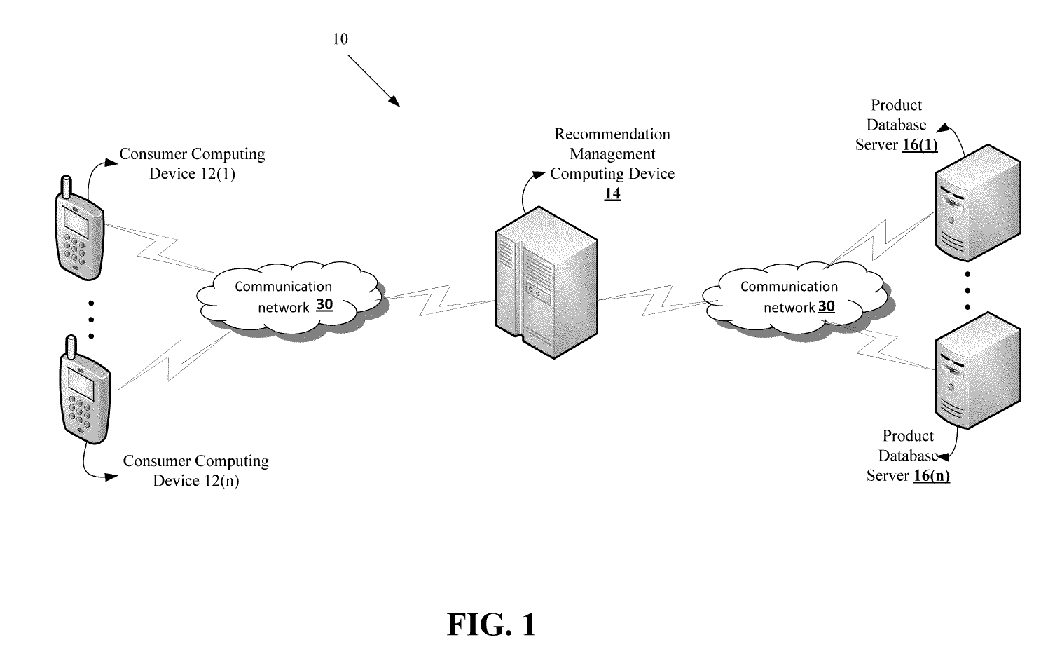

In this example illustrated in FIG. 1, the environment 10 includes a recommendation management computing device 14, a plurality of consumer computing devices 12(1)-12(n) and a plurality of product database servers 16(1)-16(n) which are coupled together by one or more communication networks 30, although the environment can include other types and/or numbers of devices, components, and/or elements in a variety of other topologies and deployments. While not shown, the exemplary environment may include additional components which are well known to those of ordinary skill in the art and thus will not be described here. This technology provides a number of advantages including providing more effective methods, non-transitory computer readable medium and devices for providing targeted notifications for color matched consumer products using by way of example the color based product recommendation module within the recommendation management computing device 14.

Referring more specifically to FIG. 1, the recommendation management computing device 14 interacts with one or more of the plurality of consumer computing devices 12(1)-12(n) and one or more of the plurality of product database servers 16(1)-16(n) through the one or more communication networks 30, although the recommendation management computing device 14 can interact with the plurality of product database servers 16(1)-16(n), using other methods or techniques. Communication networks include local area networks (LAN), wide area network (WAN), 3G technologies, GPRS or EDGE technologies, although the communication networks and the telecommunication network can include other types and/or numbers of networks and other network topologies.

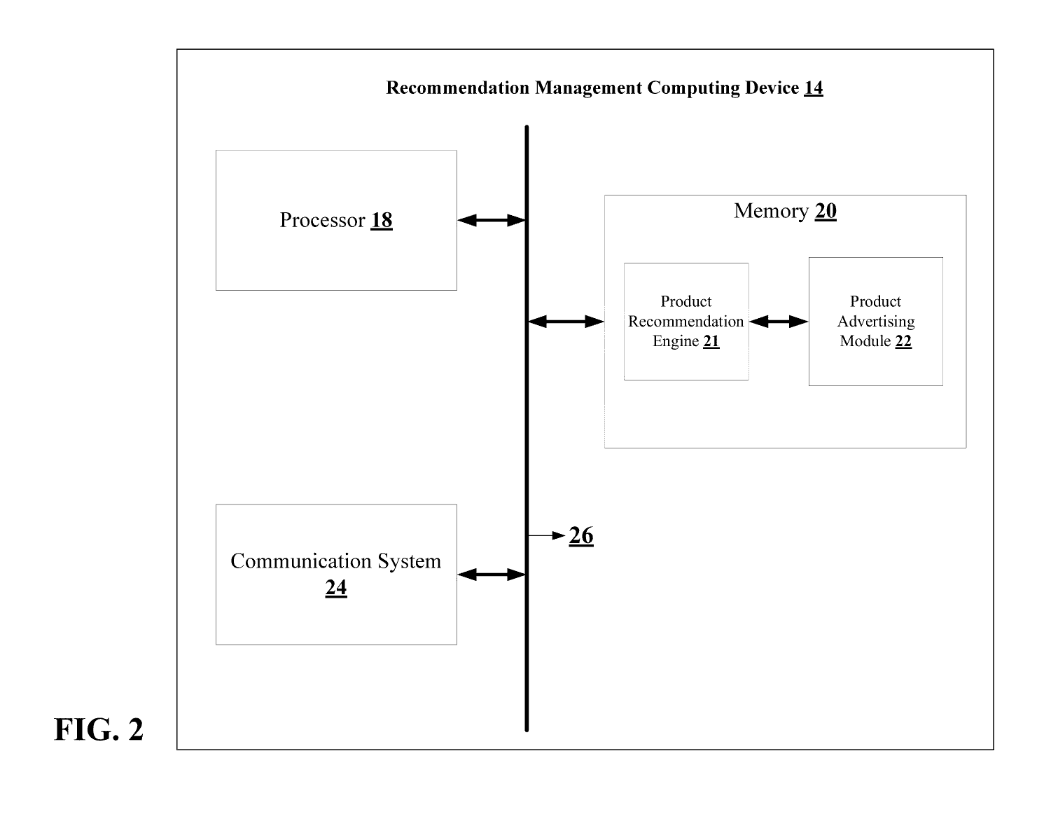

The recommendation management computing device 14 facilitates providing targeted notifications for color matched consumer products as illustrated and described with the examples herein, although the recommendation management computing device 14 may perform other types and/or numbers of functions and in other types of networks. Referring specifically to FIG. 2, the recommendation management computing device 14 includes at least one processor 18, memory 20, and communication system 24 which are coupled together by bus 26, although the recommendation management computing device 14 may comprise other types and/or numbers of elements in other configurations.

Processor(s) 18 may execute one or more computer-executable instructions stored in the memory 20 for the methods illustrated and described with reference to the examples herein, although the processor(s) can execute other types and/or numbers of instructions and perform other types and/or numbers of operations. The processor(s) 18 may comprise one or more central processing units (“CPUs”) or general purpose processors with one or more processing cores, such as AMD® processor(s), although other types of processor(s) could be used (e.g., Intel®).

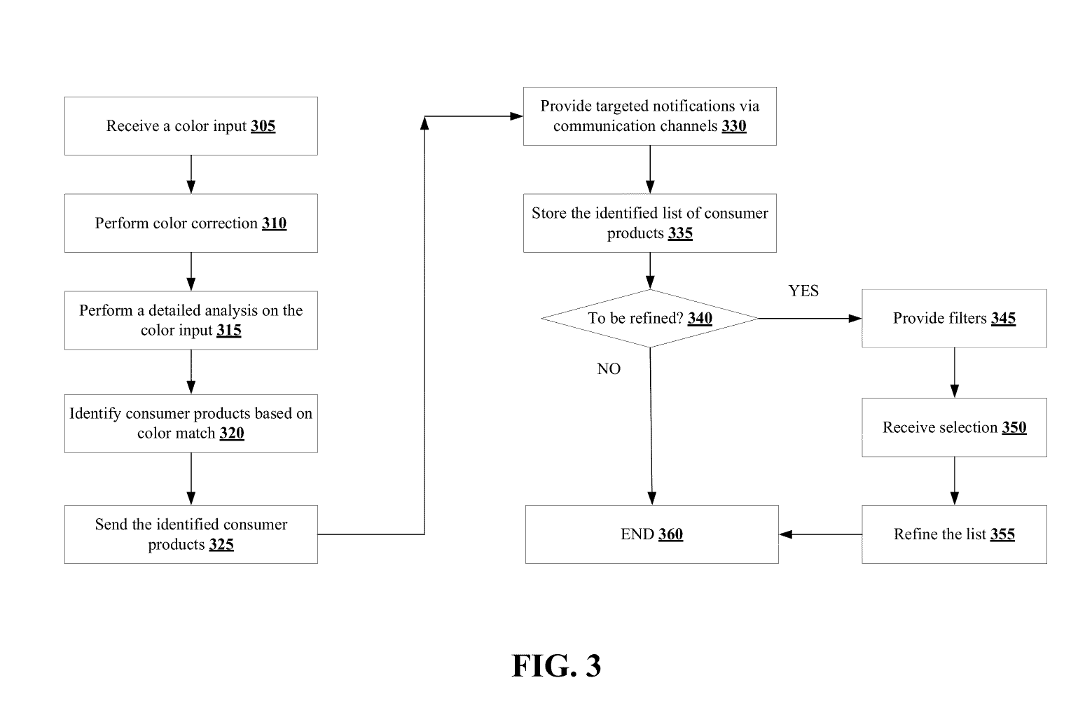

Memory 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 20 may store one or more programmed instructions of this technology as illustrated and described with reference to the examples herein that may be executed by the one or more processor(s). The flow charts shown in FIG. 3 is representative of example steps or actions of this technology that may be embodied or expressed as one or more non-transitory computer or machine readable having stored instructions stored in memory that may be executed by the processor(s).

Additionally as illustrated in FIG. 2, the memory 20 of the recommendation management computing device 14 may include a product recommendation engine 21 and a color based product recommendation module 22, although the memory 20 can include other types and/or numbers of modules or other programmed instructions to assist the recommendation management computing device 14 for providing targeted notifications for color matched consumer products. In this example, the product recommendation engine 21 is configured to identify consumer products based on a color match using technique illustrated and described in US Patent Application Publication No. 2013/0300761, entitled “Method and System for Color Matching and Color Recommendation”, which is incorporated here in its entirety, although the product recommendation engine 21 can use other techniques to identify consumer products.

Next, the color based product recommendation module 22 within the recommendation management computing device 14 is configured to assist with providing targeted notifications to one or more of the plurality of consumer computing devices 12(1)-12(n) over one or more of a variety of different communication channels, although the color based product recommendation module 22 can be configured to perform other types and/or numbers of functions. By way of example only, the different communication channels over which this technology may execute include a text message, a voice call, web flash sales, an email alert or a targeted notification popping up on an application executing within the plurality of consumer computing devices 12(1)-12(n), or an alert on a social media platform, although other types and/or numbers of different communication channels could be used.

The recommendation management computing device 14 includes communication system 24 which is used to operatively couple and communicate between the recommendation management computing device 14, plurality of consumer computing devices 12(1)-12(n) and the plurality of product database servers 16(1)-16(n) and which are all coupled together by communication network 30, although other types and/or numbers of systems, devices, or elements and other types and/or numbers of communication networks or systems with other types and/or numbers of connections and configurations can be used. In this example, the communication network 30 can be a Wide Area Network (WAN), or a Local Area Network (LAN), although the communication network can include other types of topologies supporting communication. By way of example only, the one or more the communications networks can use TCP/IP over Ethernet and industry-standard protocols, including NFS, CIFS, SOAP, XML, LDAP, and SNMP, although other types and/or numbers of communication networks, such as a direct connection, a local area network, a wide area network, modems and phone lines, e-mail, and wireless communication technology, each having their own communications protocols, can be used.

In this example, the bus 26 is a hyper-transport bus in this example, although other bus types and links may be used, such as PCI.

Each of the plurality of consumer computing devices 12(1)-12(n) may includes a processor, a memory, a camera, an input device, display device, and communication system which are coupled together by bus, although the consumer computing device may comprise other types and/or numbers of elements in other configurations. Each of the plurality of consumer computing devices 12(1)-12(n) may be coupled with the recommendation management computing device 14 via communication network 30, although the plurality of consumer computing devices 12(1)-12(n) and recommendation management computing device 14 can be coupled via other network topologies. In this example, the consumer using the consumer computing device interacts with the recommendation management computing device 14 to obtain targeted notifications on consumer products which are matched based on the color, although the plurality of consumer computing devices 12(1)-12(n) can receive other types or amounts of information.

Next, each of the plurality of product database servers 16(1)-16(n) may include at least a processor, memory, an input device, display device, and communication system which are coupled together by bus, although the plurality of product database servers 16(1)-16(n) may comprise other types and/or numbers of elements in other configurations. Each of the plurality of product database servers 16(1)-16(n) may be coupled with the recommendation management computing device 14 via the communication network 30, although the plurality of product database servers 16(1)-16(n) and recommendation management computing device 14 can be coupled via other network topologies. In this example, the plurality of product database servers 16(1)-16(n) includes information associated with consumer products, although the plurality of product database servers 16(1)-16(n) can include other types or amounts of information. The recommendation management computing device 14 uses the plurality of product database servers 16(1)-16(n) to obtain consumer products based on a color match, and provide targeted notifications to the plurality of consumer computing devices 12(1)-12(n).

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein. Exemplary methods for providing targeted notifications for color matched consumer products will now be described below with reference to FIGS. 1-3.

In step 305, the recommendation management computing device 14 receives a color image from one of a plurality of consumer computing devices 12(1)-12(n), although the recommendation management computing device 14 can receive other types or inputs from other devices. In this example, the color image can be a single or multiple digital images that a consumer using the requesting one of the plurality of consumer computing devices 12(1)-12(n) can send using the requesting one of the plurality of consumer computing devices 12(1)-12(n), although other types of color images or other color inputs could be used. By way of example only, if a consumer using the requesting one of the plurality of consumer computing devices 12(1)-12(n) is looking for a cosmetic product, the consumer may upload the image of the consumer's face. Additionally, if a consumer is looking for a fashion product such as matching shoes, item(s) of clothing, and/or coordinating accessories, then the consumer may send one or more images using the requesting one of the plurality of consumer computing devices 12(1)-12(n). Furthermore, if the consumer of the requesting one of the plurality of consumer computing devices 12(1)-12(n) is looking for furniture matching for the user's living room, the consumer may send one or more images of the living room which includes painted walls and other furniture.

In another example, the recommendation management computing device 14 can also obtain one or more images from social media platforms associated with the consumer using the requesting one of the plurality of consumer computing devices 12(1)-12(n).

Next in step 310, the recommendation management computing device 14 can color correct the received color image from the requesting one of the plurality of consumer computing devices 12(1)-12(n) to substantially obtain the original color characteristics of the object within the received images. This step is performed by the recommendation management computing device 14 to correct the images which may be captured under different light conditions and/or with different type or quality of equipment such as digital cameras, or mobile phone cameras etc. By way of example only, excessive lighting can introduce glare effects and/or make the colors appear lighter than they actually appear. In contrast, too little light can make the colors in the image appear darker.

Next in step 315, the recommendation management computing device 14 performs a detailed analysis on the color corrected color image. In this example, the recommendation management computing device 14 performs the detailed analysis to determine which color is to be used as a reference color for color matching and/or color recommendation. An example of this technique of performing this detailed analysis is further illustrated in US Patent Application Publication No. 2013/0300761, entitled “Method and System for Color Matching and Color Recommendation”, which is incorporated here in its entirety.

Next in step 320, the recommendation management computing device 14 uses one or more reference colors as a basis to find matching and coordinating consumer products for the consumer using the requesting one of the plurality of consumer computing devices 12(1)-12(n). In this example, the product recommendation engine 21 within the recommendation management computing device 14 identifies one or more consumer products from one of the plurality of product database servers 16(1)-16(n), although the recommendation management computing device 14 can identify the consumer products from other locations and/or in other manners from other databases. By way of example only, if the consumer had sent an image of a shirt using the requesting one of the plurality of consumer computing devices 12(1)-12(n), then the recommendation management computing device 14 can identify a tie based on the reference color of the shirt. In this example, the product recommendation engine 21 of the recommendation management computing device 14 includes color matching rules to assist the recommendation management computing device 14 to identify products from the plurality of product database servers 16(1)-16(n) based on the color match. Additionally, the product recommendation engine 21 within the recommendation management computing device 14 can use stored historical information associated with the consumer such as consumer's affinity towards certain color characteristics (color temperature, contrast, color chroma) as a basis to find matching and coordinating consumer products for the consumer using the requesting one of the plurality of consumer computing devices 12(1)-12(n). Alternatively in another example, the product recommendation engine 21 of the recommendation management computing device 14 can identify identifies one or more consumer products from one of the plurality of product database servers 16(1)-16(n) based on the search history in the requesting one of the plurality of consumer computing devices 12(1)-12(n), photos searched and shared by the consumer using the requesting one of the plurality of consumer computing devices 12(1)-12(n), although other types or amounts of parameters can be considered while identifying one or more consumer products.

In another example, the product recommendation engine 21 within the recommendation management computing device 14 identifies one or more consumer products for the consumer using the requesting one of the plurality of consumer computing devices 12(1)-12(n) based on ongoing marketing campaigns. By way of example only, a manufacturer of a tie may run a campaign for a particular color pattern of a tie. Using this marketing information, the product recommendation engine 21 within the recommendation management computing device 14 scans all the existing consumer profiles to check for a consumer who had uploaded an image shirt or a suit that would match the color of the tie using the color matching techniques illustrated in US Patent Application Publication No. 2013/0300761, entitled “Method and System for Color Matching and Color Recommendation”, which is incorporated here in its entirety.

In yet another example, the product recommendation engine 21 within the recommendation management computing device 14 can identify the consumer products based on a color theme of an upcoming holiday or an event. By way of example only, during St. Patricks' week, the product recommendation engine 21 can identify a green color hat or green color sweatshirt as a consumer product for consumers having uploaded an image of a shirt, or a polo shirt that would color match with the green color hat. Similarly, the product recommendation engine 21 within the recommendation management computing device 14 can identify consumer products with different shades or red color during the week of Valentines Day.

Next in step 325, the color based product recommendation module 21 within the recommendation management computing device 14 sends a list of the identified color matched consumer products to the requesting one of the plurality of consumer computing devices 12(1)-12(n). By way of example only, the color based product recommendation module 21 sends the list of the identified color matched consumer products to an application executing within the requesting one of the plurality of consumer computing devices 12(1)-12(n), which in turn displays the list of the color matched consumer products, although the recommendation management computing device 14 can send the color matched consumer products using other techniques. In addition to providing a list of the color matched consumer products, the color based product recommendation module 21 provides reasons to have identified the consumer product to the requesting one of the plurality of consumer computing devices 12(1)-12(n). By way of example only, the reason for recommendation is based on the percentage of color match, identified features of the consumer of the consumer computing device, or rating or review of the consumer product for the color match by way of example, although the recommendations can be based on other criteria.

Next in step 330, the color based product recommendation module 21 within the recommendation management computing device 14 may provides targeted notifications via one or more different types of communication channels to the requesting one of the plurality of consumer computing devices 12(1)-12(n) for the identified color matched consumer products. For example, these types of communication channel may includes a push targeted notification on an application executing within the requesting one of the plurality of consumer computing devices 12(1)-12(n), an email, a text message, a voice call, social media platforms alerts and/or web flash sales, although the communication channel can include other types of advertising mediums. Further, the color based product recommendation module 21 can also provide targeted gift notifications to family and/or friends of the consumer using the requesting one of the plurality of consumer computing devices 12(1)-12(n) indicating the identified color matched consumer products. In this example, the product recommendation module 21 within the recommendation management computing device 14 identifies the family and/or friends via the social network platform associated with the consumer using the requesting one of the plurality of consumer computing devices 12(1)-12(n), although the product recommendation module can use other techniques to identify family and/or friends associated with the consumer. The family and/or friends can use these targeted gift notifications provided by the product recommendation module 21 to purchase gifts for the consumer on days of special occasions such as birthday or anniversaries. Additionally in this example, the color based product recommendation module 21 within the recommendation management computing device 14 can also send out notifications to retailers of the consumer products indicating the color matched consumer products and information associated with the consumer using the requesting one of the plurality of consumer computing devices 12(1)-12(n). Using this information, the retailers of the consumer products can send out notification, deals and/or discount to the consumer using the requesting one of the plurality of consumer computing devices 12(1)-12(n) separately. Furthermore, the color based product recommendation module 21 within the recommendation management computing device 14 can also provide notification to the retailers or the requesting one of the plurality of consumer computing devices 12(1)-12(n) regarding the one or more consumer products that were identified based on the search history and photos that were shared or searched.

Additionally in this example, the recommendation management computing device 14 may also identify the geographical location of the consumer via the global positioning system function on the requesting one of the plurality of consumer computing devices 12(1)-12(n) and also provide targeted notification to the consumer when the consumer is physically or geographically at a closer location to the identified color matched consumer products. Alternatively, the color based product recommendation module 21 within the recommendation management computing device 14 can also provide targeted notifications to the requesting one of the plurality of consumer computing devices 12(1)-12(n) when there are deals or coupons or discounts available for the consumer products present in the provided list. Optionally, the recommendation management computing device 14 provides one or more features to the requesting one of the plurality of consumer computing devices 12(1)-12(n) for to the identified color matched consumer products. By way of example only, one or more features includes assisting the consumer with buying a desired consumer product, marking the provided consumer product as a favorite, adding a consumer product to a wish list, sharing the consumer product to another consumer via text or email or other social media platforms, although the recommendation management computing device 14 can provide other types or amounts of features. Additionally, incentives or rewards could be provided to the consumer using the requesting one of the plurality of consumer computing devices 12(1)-12(n) when at least one of the identified consumer products in the provided list is purchased.

In step 335, the recommendation management computing device 14 also stores the identified consumer products within the memory 20 for purpose of any future recommendations, although the recommendation management computing device 14 can store the identified consumer products at other memory locations.

Next in step 340, the recommendation management computing device 14 determines when the provided list of the consumer products is to be refined. When the recommendation management computing device 14 determines that the provided list is to be refined, then the Yes branch is taken to step 345.

In step 345, the recommendation management computing device 14 provides one or more filters to the requesting one of the plurality of consumer computing devices 12(1)-12(n). By way of example only, the filters can be a percentage of color match, price range of the consumer product, brand of the consumer product, seller of the consumer product, although the recommendation management computing device 14 can provide other types or numbers of filters.

Next in step 350, the recommendation management computing device 14 receives selection of one or more of the provided filters from the requesting one of the plurality of consumer computing devices 12(1)-12(n). Upon receiving the selection of filters, the recommendation management computing device 14 refines the previously provided list by applying the selected filters, although the recommendation management computing device 14 can refine the previously provided list based on other parameters.

In step 355, the recommendation management computing device 14 provides the refined list to the requesting one of the plurality of consumer computing devices 12(1)-12(n).

However if back in step 340, when the recommendation management computing device 14 determined there was no requirement to refine the list, then the No branch is taken to step 360 where the exemplary process ends.

Accordingly, as illustrated and described by way of the examples herein this technology provides methods, non-transitory computer readable media and apparatuses that assist providing targeted notifications for color matches consumer products. One of several advantages of this exemplary technology is that the targeted notifications are provided in real-time when the consumer is either physically or geographically closer to the color matched consumer product. Further, this exemplary technology advantageously requires minimum information from the consumer, such as an image, and does not require any other information to identify a consumer product.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for providing targeted notifications for color matched consumer products, the method comprising:
obtaining, by a recommendation management computing device, a color image of an object from a consumer computing device;
analyzing, by the recommendation management computing device, the object in the obtained color image to identify one or more color characteristics;
identifying, by the recommendation management computing device, one or more consumer products at least based on the identified color characteristics; and
providing, by the recommendation management computing device, one or more targeted notifications for the identified one or more consumer products via one or more communication channels to the consumer computing device.

2. The method as set forth in claim 1 wherein the providing further comprises providing, by the recommendation management computing device, a reason for the recommendation of the identified one or more products to the consumer.

3. The method as set forth in claim 1 wherein the providing further comprises providing, by the recommendation management computing device, the one or more targeted notifications to the consumer when the consumer is at a location geographically close to the identified one or more products.

4. The method as set forth in claim 1 wherein the one or more communication channels further comprises one or more of a text message, a voice call, a push targeted notification on an existing application executing on the recommendation management computing device, a gift notification or a social media post.

5. The method as set forth in claim 1 further comprising storing, by the recommendation management computing device, the identified one or more consumer products.

6. A non-transitory computer readable medium having stored thereon instructions for providing targeted notifications for recommended consumer products comprising machine executable code which when executed by at least one processor, causes the processor to perform steps comprising:
obtaining a color image of an object from a consumer computing device;
analyzing the object in the obtained color image to identify one or more color characteristics;
identifying one or more consumer products at least based on the identified color characteristics; and
providing one or more targeted notifications for the identified one or more consumer products via one or more communication channels to the consumer computing device.

7. The medium as set forth in claim 6 wherein the providing further comprises, providing a reason for the recommendation of the identified one or more products to the consumer.

8. The medium as set forth in claim 6 wherein the providing further comprises providing the one or more targeted notifications to the consumer when the consumer is at a location geographically close to the identified one or more products.

9. The medium as set forth in claim 6 wherein the one or more communication channels further comprises one or more of a text message, a voice call, a push targeted notification on an existing application executing on a recommendation management computing device, a gift notification or a social media post.

10. The medium as set forth in claim 6 further comprising storing the identified one or more consumer products.

11. A recommendation management computing device comprising:
a processor;
a memory, wherein the memory coupled to the processor which are configured to execute programmed instructions stored in the memory comprising:
obtaining a color image of an object from a consumer computing device;
analyzing the object in the obtained color image to identify one or more color characteristics;
identifying one or more consumer products at least based on the identified color characteristics; and
providing one or more targeted notifications for the identified one or more consumer products via one or more communication channels to the consumer computing device.

12. The device as set forth in claim 11 wherein the processor is further configured to execute programmed instructions stored in the memory for the providing further comprises, providing a reason for the recommendation of the identified one or more products to the consumer.

13. The device as set forth in claim 11 wherein the processor is further configured to execute programmed instructions stored in the memory for the providing further comprises providing the one or more targeted notifications to the consumer when the consumer is at a location geographically close to the identified one or more products.

14. The device as set forth in claim 11 wherein the one or more communication channels further comprises one or more of a text message, a voice call, a push targeted notification on an existing application executing on the recommendation management computing device, a gift notification or a social media post.

15. The device as set forth in claim 11 wherein the processor is further configured to execute programmed instructions stored in the memory further comprising storing the identified one or more consumer products.
